(19) United States
(12) Patent Application Publication
(10) Pub. No.: US 2021/0375526 A1
(43) Pub. Date: Dec. 2, 2021

(54) COIL COMPONENT

(71) Applicant: Murata Manufacturing Co., Ltd., Kyoto-fu (JP)

(72) Inventors: Tarou TSUJIBAYASHI, Nagaokakyo-shi (JP); Masashi MIYAMOTO, Nagaokakyo-shi (JP)

(73) Assignee: Murata Manufacturing Co., Ltd., Kyoto-fu (JP)

(21) Appl. No.: 17/331,476

(22) Filed: May 26, 2021

(30) Foreign Application Priority Data
May 27, 2020 (JP) 2020-092169

(51) Int. Cl. H01F 27/28; H01F 27/29; H01F 27/24

(52) U.S. Cl. CPC H01F 27/2823; H01F 27/24; H01F 27/29

(57) ABSTRACT

Recesses are formed by chamfers grooved along ridges of a wire-wound core portion having a substantially quadrangular-prism shape. Each of the recesses has a sloping surface that is inclined at an obtuse angle with respect to inner end surfaces of flanges and that extends in a direction away from the inner end surfaces. The sloping surface improves mechanical strength of a core. Preferably, an end portion of the sloping surface closer to the corresponding inner end surface is aligned with the peripheral surface or located closer to a center axis of the wire-wound core portion than the peripheral surface in a direction from the peripheral surface toward the center axis.

### CROSS-REFERENCE TO RELATED APPLICATION

This application claims benefit of priority to Japanese Patent Application No. 2020-092169, filed May 27, 2020, the entire content of which is incorporated herein by reference.

### BACKGROUND

### Technical Field

The present disclosure relates to a coil component, and particularly, a wound coil component including a core including a wire-wound core portion around which a wire is wound, and flanges disposed at opposite end portions of the wire-wound core portion.

### Background Art

A wound coil component usually includes a core that includes a wire-wound core portion and flanges disposed at opposite end portions of the wire-wound core portion. As illustrated in FIG. 17, a core in such a coil component is disposed to have the axial direction of the wire-wound core portion extending parallel to a mount surface.

FIG. 17 illustrates a core 2 in a coil component mounted on a mount substrate 1 in a cross section taken perpendicular to a mount surface 7 of the mount substrate 1. The core 2 is formed from, for example, alumina or ferrite, and includes a wire-wound core portion 3 and flanges 4 and 5 respectively disposed at opposite end portions of the wire-wound core portion 3. The coil component is mounted on the mount substrate 1 by soldering. Here, the core 2 is disposed to have the direction of an axis 6 of the wire-wound core portion 3 extending parallel to the mount surface 7 of the mount substrate 1.

In the above state, upon receiving any force due to, for example, thermal expansion and thermal contraction resulting from a temperature change, the mount substrate 1 may be distorted. When the core 2 has insufficient mechanical strength, the distortion of the mount substrate 1 may cause a mechanical damage such as a crack 8, as schematically illustrated in FIG. 17. As illustrated, the crack 8 is usually formed from the boundary between the wire-wound core portion 3 and the flange 4 or 5 (flange 5 in FIG. 17).

For example, Japanese Unexamined Patent Application Publication No. 2018-198234 describes a core including a sloping surface at the boundary between a wire-wound core portion and each of flanges shown in FIGS. 1 to 3 of Patent Document 1. More specifically, the sloping surface extends throughout the periphery at a portion where the peripheral surface of the wire-wound core portion crosses the inner end surface of each flange facing the wire-wound core portion. The sloping surface extends at an obtuse angle with respect to the inner end surface of the flange. Such a sloping surface can reduce stress caused at the boundary between the wire-wound core portion and each flange, and thus can hinder a crack 8 illustrated in FIG. 17 from being formed.

FIG. 18 illustrates part of a core 10 including a sloping surface 9, described above, in an enlarged manner. The sloping surface 9 extends throughout the periphery at a portion where a peripheral surface 12 of a wire-wound core portion 11 crosses an inner end surface 14 of a flange 13 facing the wire-wound core portion 11. The sloping surface 9 extends at an obtuse angle with respect to the inner end surface 14 of the flange 13.

Only from the viewpoint of preventing the occurrence of the crack 8 illustrated in FIG. 17, the sloping surface 9 preferably extends over a wide range from the inner end surface 14 of the flange 13 to the peripheral surface 12 of the wire-wound core portion 11. However, as illustrated in FIG. 18, a wire 15 wound around the peripheral surface 12 of the wire-wound core portion 11 easily slips over the sloping surface 9. Thus, the sloping surface 9 does not easily allow the wire 15 to be wound therearound. This causes a relatively wide gap 16 between a turn of the wound wire 15 closest to the flange 13 and the inner end surface 14 of the flange 13.

Thus, as the sloping surface 9 extends to a wider range, the gap 16 is further widened. Thus, the area of the peripheral surface 12 of the wire-wound core portion 11 that allows the wire 15 to be smoothly wound therearound may be further reduced. This prevents achievement of size reduction of a coil component and securing of sufficient inductance in parallel.

### SUMMARY

Accordingly, the present disclosure provides a coil component that can prevent or reduce possible mechanical damage, such as cracks, while including no sloping surface or a sloping surface extending over a narrow area at a portion where the peripheral surface of the wire-wound core portion crosses the inner end surface of each of flanges.

Preferred embodiments of the present disclosure are directed to a coil component including a core, terminal electrodes, and a wire. The core includes a wire-wound core portion including a peripheral surface and extending in an axial direction, and flanges disposed on end portions of the wire-wound core portion opposite to each other in the axial direction. The axial direction of the wire-wound core portion extends parallel to a mount surface. The terminal electrodes are disposed at portions of the flanges facing at least the mount surface. The wire is wound around the peripheral surface of the wire-wound core portion and connected to the terminal electrodes.

Each of the flanges includes an inner end surface facing the wire-wound core portion and on which a corresponding one of the end portions of the wire-wound core portion is positioned, and an outer end surface facing outward away from the inner end surface.

Also, the present disclosure has the following structure. Recesses are formed at portions of the wire-wound core portion in a peripheral direction where the peripheral surface of the wire-wound core portion crosses the inner end surfaces of the flanges. A sloping surface is formed in each of the recesses, and the sloping surface is inclined at an obtuse angle with respect to a corresponding one of the inner end surfaces and extends in a direction away from the inner end surface.

According to an aspect of the present disclosure, the sloping surface improves mechanical strength of the core. Thus, even when a mount substrate is distorted while having a coil component mounted thereon, the core can prevent or reduce possible mechanical damage such as cracks.

The sloping surface is formed within a recess. Thus, the entirety or most part of the sloping surface is housed within the space defined by the recess. The recess is disposed on the wire-wound core portion at a portion where the peripheral surface of the wire-wound core portion crosses the inner end surface of each of the flanges, but extends only partially in the peripheral direction. Thus, the sloping surface is prevented from substantially hindering winding of a wire around the peripheral surface of the wire-wound core portion.

Thus, the peripheral surface of the wire-wound core portion can secure a sufficiently large area that allows a wire to be wound therearound. This structure can secure a sufficient inductance while achieving size reduction of the coil component.

The entirety or most part of the sloping surface can be housed within the space defined by the recess. This structure can at least partially prevent the sloping surface, even when long, from reducing the area around which a wire is wound. This structure can further improve mechanical strength of the core by increasing the length of the sloping surface.

Other features, elements, characteristics and advantages of the present disclosure will become more apparent from the following detailed description of preferred embodiments of the present disclosure with reference to the attached drawings.

### BRIEF DESCRIPTION OF THE DRAWINGS

FIG. 1 is a perspective view of the appearance of a coil component according to a first embodiment of the present disclosure, with a surface of the coil component facing the mount surface directed upward in the drawing;

FIG. 2 is a perspective view of the appearance of a core included in the coil component illustrated in FIG. 1, with the core being kept in a position illustrated in FIG. 1;

FIG. 3 is a plan view of the core illustrated in FIG. 2 in the position illustrated in FIG. 1;

FIG. 4 is a front view of the core illustrated in FIG. 2 in the position illustrated in FIG. 1;

FIG. 5 is a cross-sectional view taken along line V-V in FIG. 3;

FIG. 6 is a cross-sectional view taken along line VI-VI in FIG. 3;

FIG. 7 is an enlarged view of a portion VII in FIG. 3;

FIG. 8 is an enlarged view of a portion VIII in FIG. 4;

FIG. 9 is an enlarged view of a portion IX in FIG. 2;

FIG. 10 is a diagram corresponding to FIG. 18, illustrating the core and a wire wound around a wire-wound core portion;

FIG. 11 is a diagram corresponding to FIG. 2, illustrating the appearance of a core included in a coil component according to a second embodiment of the present disclosure;

FIG. 12 is an enlarged view corresponding to FIG. 8, illustrating part of the core illustrated in FIG. 11;

FIG. 13 is a diagram corresponding to FIG. 2, illustrating the appearance of a core included in a coil component according to a third embodiment of the present disclosure;

FIG. 14 is an enlarged view corresponding to FIG. 8, illustrating part of the core illustrated in FIG. 13;

FIG. 15 is a diagram corresponding to FIG. 2, illustrating the appearance of a core included in a coil component according to a fourth embodiment of the present disclosure;

FIG. 16 is an enlarged view corresponding to FIG. 8, illustrating part of the core illustrated in FIG. 15;

FIG. 17 is a schematic cross-sectional view of a mount substrate 1 and a core having a crack; and

FIG. 18 is a diagram corresponding to FIG. 10, illustrating a core included in a coil component described in Patent Document 1 and a wire wound around a wire-wound core portion.

### DETAILED DESCRIPTION

### First Embodiment

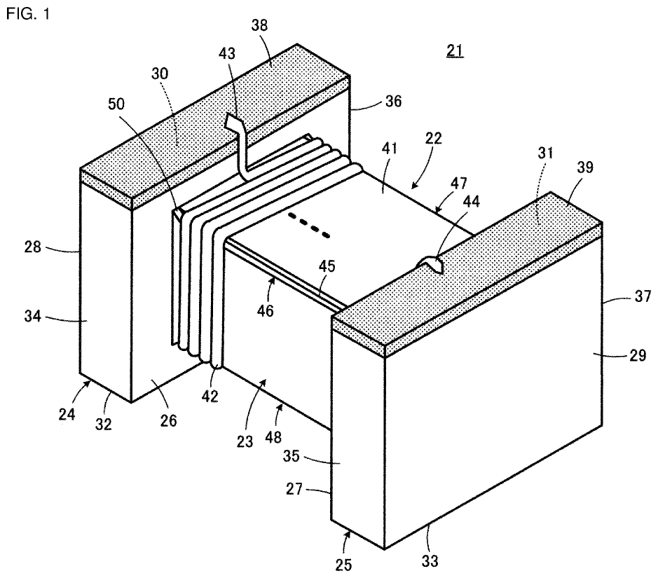

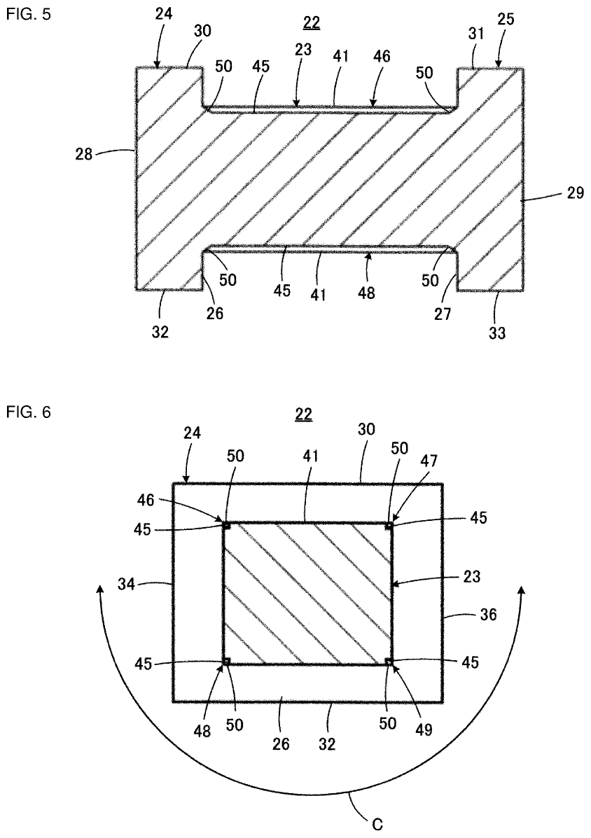

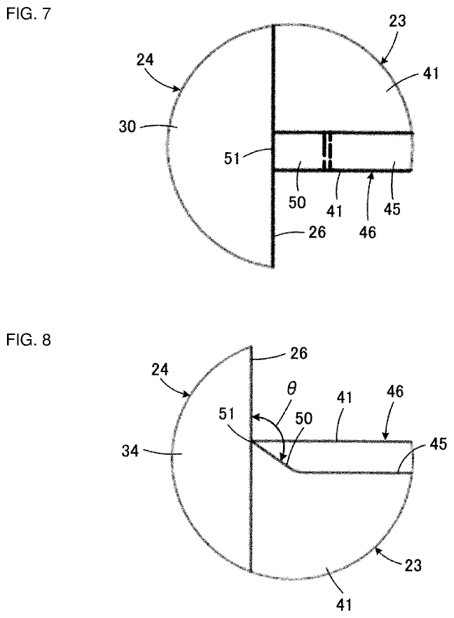

A coil component 21 according to a first embodiment of the present disclosure will be described with reference to FIGS. 1 to 10.

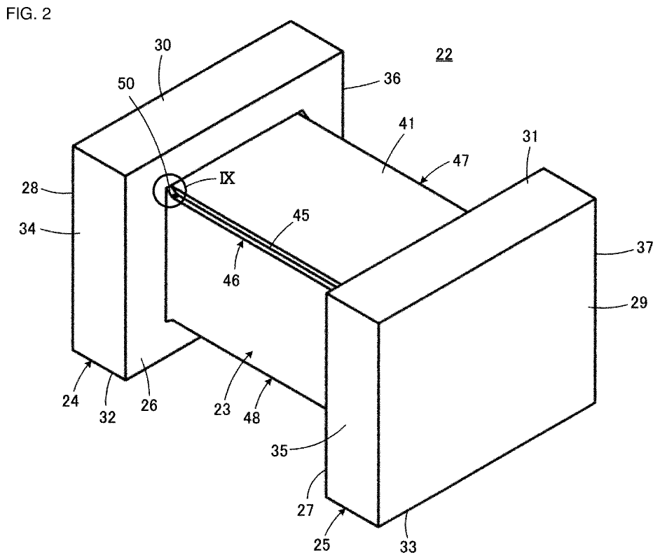

As illustrated in FIG. 1, the coil component 21 is a wire-wound coil, and includes a substantially drum-shaped core 22. The core 22 is a single component illustrated in FIGS. 2 to 6. The core 22 is formed from a non-conductive material such as alumina or ferrite, and includes a wire-wound core portion 23, and a first flange 24 and a second flange 25 disposed at opposite end portions of the wire-wound core portion 23.

The first flange 24 includes an inner end surface 26, facing the wire-wound core portion 23 and on which an end portion of the wire-wound core portion 23 is positioned, and an outer end surface 28, facing outward away from the inner end surface 26. The first flange 24 also includes a bottom surface 30 facing a mount substrate (not illustrated) when mounted, a top surface 32 opposite to the bottom surface 30, a first side surface 34, and a second side surface 36 opposite to the first side surface 34.

The second flange 25 includes an inner end surface 27, facing the wire-wound core portion 23 and on which an end portion of the wire-wound core portion 23 is positioned, and an outer end surface 29, facing outward away from the inner end surface 27. The second flange 25 also includes a bottom surface 31 facing a mount substrate (not illustrated) when mounted, a top surface 33 opposite to the bottom surface 31, a first side surface 35, and a second side surface 37 opposite to the first side surface 35.

A first terminal electrode 38 is disposed on a surface of the first flange 24 facing the mount surface. A second terminal electrode 39 is disposed on a surface of the second flange 25 facing the mount surface. More specifically, the first terminal electrode 38 covers the bottom surface 30 of the first flange 24, and extends to part of the inner end surface 26, the outer end surface 28, the first side surface 34, and the second side surface 36. The second terminal electrode 39 covers the bottom surface 31 of the second flange 25, and extends to part of the inner end surface 27, the outer end surface 29, the first side surface 35, and the second side surface 37.

The terminal electrodes 38 and 39 are formed by, for example, baking an electroconductive paste containing Ag as an electroconductive component and sequentially applying, for example, Ni plating and Sn plating on the baked layer as appropriate. The baked layer may be formed with an electroconductive paste containing Cu as an electroconductive component instead of Ag. The plated layers disposed on the baked layer may form a Cu/Ni/Sn or Ni/Cu/Sn multilayer. Alternatively, a Pd/Au plated layer may be disposed to form an outermost layer.

The terminal electrodes 38 and 39 are formed from, for example, metal plates, and may be replaced with terminal members bonded to the flanges 24 and 25.

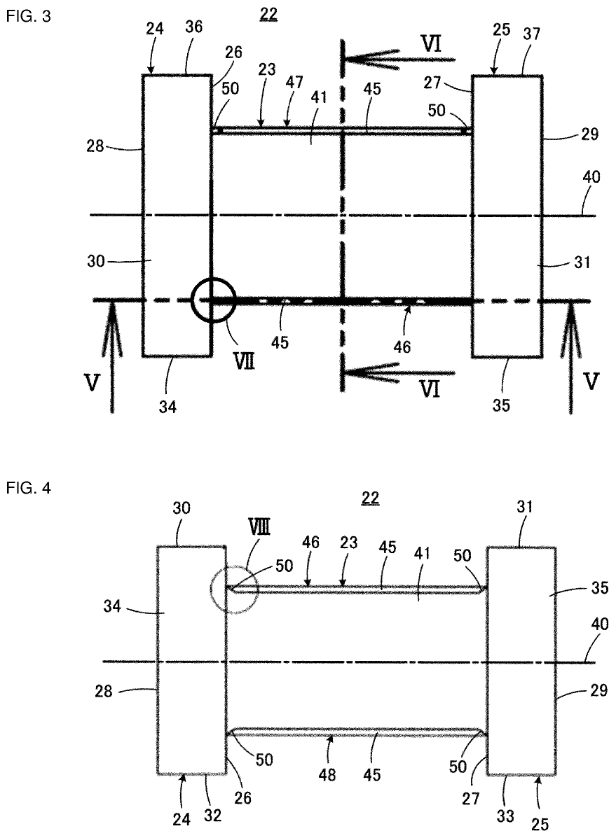

The coil component 21 is mounted on the mount substrate while having the terminal electrodes 38 and 39 soldered to the mount substrate. Here, the core 22 is disposed to have the direction of an axis 40 (refer to FIGS. 3 and 4) of the wire-wound core portion 23 extending parallel to the mount surface. Although the mount substrate having a mount surface is not illustrated, the mount surface extends parallel to a plane including the bottom surfaces 30 and 31 of the first flange 24 and the second flange 25.

The coil component 21 also includes a wire 42 wound around a peripheral surface 41 of the wire-wound core portion 23. The wire 42 constitutes an inductor, and has a first end portion 43 and a second end portion 44 respectively connected to the first terminal electrode 38 and the second terminal electrode 39. This connection is performed by, for example, thermocompression bonding. FIG. 1 omits illustration of a middle portion of the wire 42 in the longitudinal direction located around the peripheral surface 41 of the wire-wound core portion 23.

Characteristic components of the present embodiment will be described below.

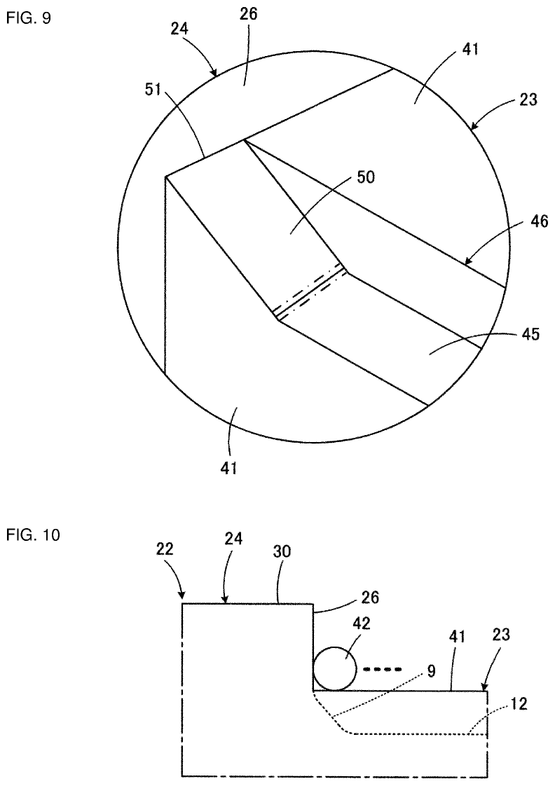

Recesses 45 are formed at part, in a peripheral direction C (refer to FIG. 6), of portions of the wire-wound core portion 23 where the peripheral surface 41 of the wire-wound core portion 23 crosses the inner end surfaces 26 and 27 of the first flange 24 and the second flange 25. In this embodiment, the wire-wound core portion 23 has a substantially polygonal-prism shape having multiple ridges extending parallel to each other, or more specifically, a substantially quadrangular-prism shape having four ridges 46 to 49 extending parallel to each other. The recesses 45 are formed by providing chamfers at the ridges 46 to 49. Chamfers are disposed on all the four ridges 46 to 49. The chamfers form grooves extending along the respective ridges 46 to 49, and these grooves are each defined by a concave surface having a substantially L-shaped cross section, as clearly illustrated in FIGS. 6 and 9. The chamfers forming the recesses 45 extend throughout the length of the ridges 46 to 49.

Sloping surfaces 50 are disposed in each of the above recesses 45. Each sloping surface 50 is inclined at an obtuse angle θ (refer to FIG. 8) with respect to the inner end surfaces 26 and 27 of the first flange 24 and the second flange 25, and extends in a direction away from the inner end surfaces 26 and 27. The sloping surface 50 has substantially entirely flat in this embodiment. The sloping surface 50 may include a concave rounded surface.

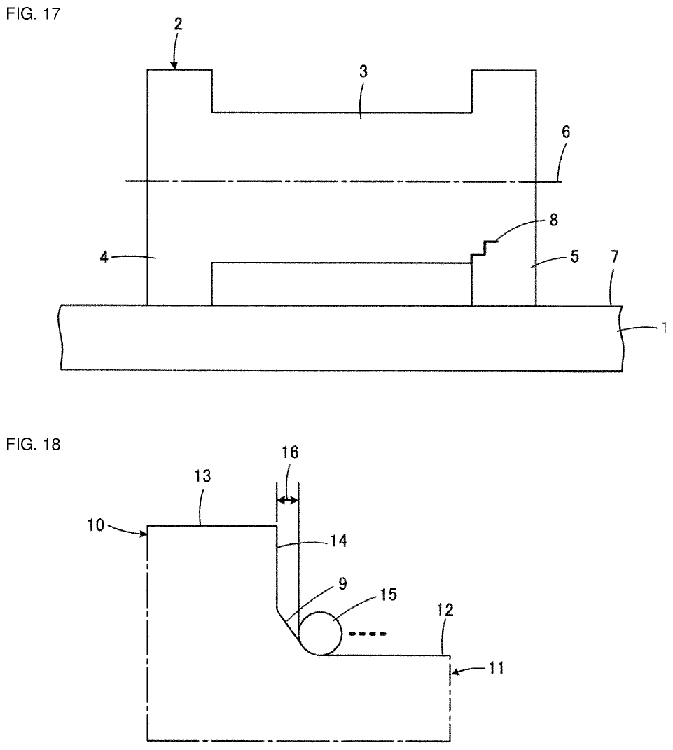

The sloping surface 50 improves mechanical strength of the core 22, and reduces stress caused at the boundary between the wire-wound core portion 23 and each of the flanges 24 and 25, and thus can prevent or reduce possible mechanical damage such as the crack 8 illustrated in FIG. 17. When viewed in the direction perpendicular to the direction of the axis 40 of the wire-wound core portion 23 and parallel to the mount surface, that is, when viewed in the direction illustrated in FIG. 8, the sloping surface 50 is inclined at an obtuse angle θ with respect to the inner end surfaces 26 and 27, and extends in a direction away from the inner end surfaces 26 and 27. When the sloping surface 50 satisfies these conditions, each recess 45 including the sloping surface 50 may be any recess located on the peripheral surface 41 of the wire-wound core portion 23 to face at least the mount surface.

As in the embodiment illustrated above, however, preferably, the recesses 45 each including the sloping surface 50 are disposed on the peripheral surface 41 of the wire-wound core portion 23 at both a portion facing the mount surface and a portion facing away from the mount surface. Thus, the coil component 21 can be efficiently manufactured without distinguishing the directionality as to the portions on the core 22 where the terminal electrodes 38 and 39 are to be formed, that is, distinguishing the bottom surfaces 30 and 31 and the top surfaces 32 and 33 of the flanges 24 and 25 from each other, thereby reducing a burden on process management.

As clearly illustrated in FIGS. 8 and 9, in this embodiment, an end portion 51 of the sloping surface 50 closer to the inner end surfaces 26 and 27 is aligned with the peripheral surface 41 in the direction from the peripheral surface 41 of the wire-wound core portion 23 toward the center axis of the wire-wound core portion 23, or more specifically, in the direction perpendicular to the mount surface. Thus, the sloping surface 50 is prevented from protruding beyond the peripheral surface 41. Similarly, the end portion 51 of the sloping surface 50 closer to the inner end surface 26 or 27 may be located closer to the center axis than the peripheral surface 41 in the direction from the peripheral surface 41 of the wire-wound core portion 23 toward the center axis of the wire-wound core portion 23, or more specifically, in the direction perpendicular to the mount surface.

As described above, each sloping surface 50 that is kept from protruding beyond the peripheral surface 41 does not hinder winding of the wire 42. This structure facilitates processing performed on the core 22.

As long as the sloping surface 50 does not hinder winding of the wire 42, the end portion 51 of the sloping surface 50 closer to the inner end surface 26 or 27 may be located on the side of the peripheral surface 41 further from the center axis in the direction from the peripheral surface 41 of the wire-wound core portion 23 toward the center axis of the wire-wound core portion 23, that is, in the direction perpendicular to the mount surface.

In the present embodiment, as the first flange 24 schematically illustrated in FIG. 10, the peripheral surface 41 of the wire-wound core portion 23 directly crosses the inner end surfaces 26 and 27 of the flanges 24 and 25. Specifically, no sloping surface is left at the boundary between the peripheral surface 41 of the wire-wound core portion 23 and each of the inner end surfaces 26 and 27 of the flanges 24 and 25. Thus, in the extreme case, the wire 42 can be wound up to the positions where it comes into contact with the inner end surfaces 26 and 27 of the flanges 24 and 25. Thus, the number of turns of the wire 42 wound around the wire-wound core portion 23 having a limited dimension can be increased to the maximum, and the size reduction of the coil component 21 and securing of a sufficient inductance can be both achieved. FIG. 1 does not clearly show the state where the wire 42 is wound up to the positions where it comes into contact with the inner end surfaces 26 and 27 of the flanges 24 and 25.

FIG. 10 illustrates the sloping surface 9 and the peripheral surface 12 of the wire-wound core portion 11 illustrated in FIG. 18 with a broken line. As is clear from the comparison between the peripheral surface 41 drawn with a solid line and the peripheral surface 12 drawn with the broken line in FIG. 10, the coil component 21 according to the present embodiment eliminates the need of providing the sloping surface 9 included in the core 10 illustrated in FIG. 18. Thus, reduction in volume of the core 22 can be prevented. This can also contribute to securing of a sufficient inductance.

In the present embodiment, the sloping surfaces 50 are located at the ridges 46 to 49 of the wire-wound core portion 23 with a substantially quadrangular-prism shape. Simulations have revealed that stress caused in the core 22 when the mount substrate is distorted is concentrated at the corners of the boundaries between the wire-wound core portion 23 and the flanges 24 and 25. Thus, it can be said that the sloping surfaces 50 for improving the mechanical strength of the core 22 will suffice if they are disposed at the boundary corners between the wire-wound core portion 23 and the flanges 24 and 25, that is, at the ridges 46 to 49 of the wire-wound core portion 23 with a substantially quadrangular-prism shape.

### Second Embodiment

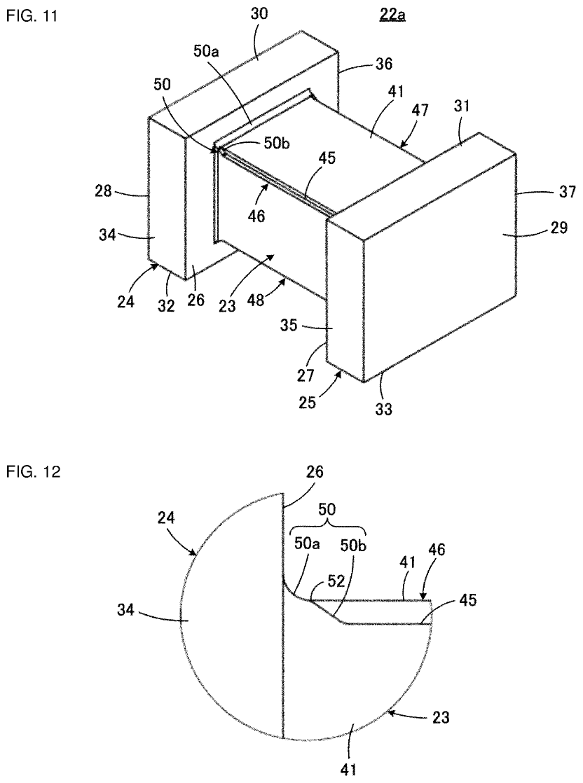

With reference to FIGS. 11 and 12, a core 22a included in a coil component according to a second embodiment of the present disclosure will be described. FIGS. 11 and 12 are diagrams respectively corresponding to FIGS. 2 and 8. In FIGS. 11 and 12, components corresponding to the components illustrated in FIGS. 2 and 8 are denoted with the same reference signs without being described redundantly.

The core 22a includes multiple sloping surfaces in each recess 45. Specifically, the sloping surface 50 includes at least a first sloping surface 50a and a second sloping surface 50b. The first sloping surface 50a and the second sloping surface 50b are continuous in this order in the direction away from the inner end surfaces 26 and 27 of the first flange 24 and the second flange 25.

The first sloping surface 50a differs from the second sloping surface 50b in terms of at least one of the angle to the inner end surfaces 26 and 27, the curvature, and the length in the axial direction. In the present embodiment, the first sloping surface 50a and the second sloping surface 50b have different curvatures. More specifically, the first sloping surface 50a includes a concave rounded surface, and the second sloping surface 50b is substantially flat.

A boundary 52 between the first sloping surface 50a and the second sloping surface 50b is preferably located at the same position as the peripheral surface 41 of the wire-wound core portion 23 or located closer to the center axis of the wire-wound core portion 23 than the peripheral surface 41 in the direction from the peripheral surface 41 toward the center axis, more specifically, in the direction perpendicular to the mount surface. This structure can substantially prevent the second sloping surface 50b from hindering winding of a wire around the peripheral surface 41 of the wire-wound core portion 23. In the illustrated embodiment, the boundary 52 is located at the same position as the peripheral surface 41.

As illustrated in FIG. 11, the first sloping surface 50a extends from the recess 45 throughout the periphery at a portion where the peripheral surface 41 of the wire-wound core portion 23 crosses each of the inner end surfaces 26 and 27 of the respective flanges 24 and 25. This structure further improves mechanical strength of the core 22a. The present embodiment is intended to clarify that the scope of the present disclosure is to include a structure including a sloping surface at part of or throughout, in the peripheral direction, the periphery of a portion where the peripheral surface of the wire-wound core portion crosses the inner end surface of each flange.

A comparative example including only the first sloping surface 50a without the second sloping surface 50b is compared with the present embodiment. The present embodiment including the first sloping surface 50a and the second sloping surface 50b can retain mechanical strength of the core 22a even when the first sloping surface 50a extends in the direction away from the inner end surfaces 26 and 27 over a narrower range. Thus, the present embodiment also including the second sloping surface 50b can minimize the loss of the wire-wound area.

As in the case of the sloping surface 9 illustrated in FIG. 18, the first sloping surface 50a extending throughout the periphery of the wire-wound core portion 23 may reduce the area of the peripheral surface 41 of the wire-wound core portion 23 that allows a wire to be wound therearound. To solve such a problem, preferably, the first sloping surface 50a has a shape and dimensions that enable the outer peripheral surface of the wire to simultaneously come into contact with both the inner end surfaces 26 and 27 of the flanges 24 and 25 and the peripheral surface 41 of the wire-wound core portion 23. For example, as illustrated in FIG. 12, for the first sloping surface 50a including a rounded surface, the rounded surface preferably has a radius of curvature shorter than or equal to the radius of the cross section of the wire.

### Third Embodiment

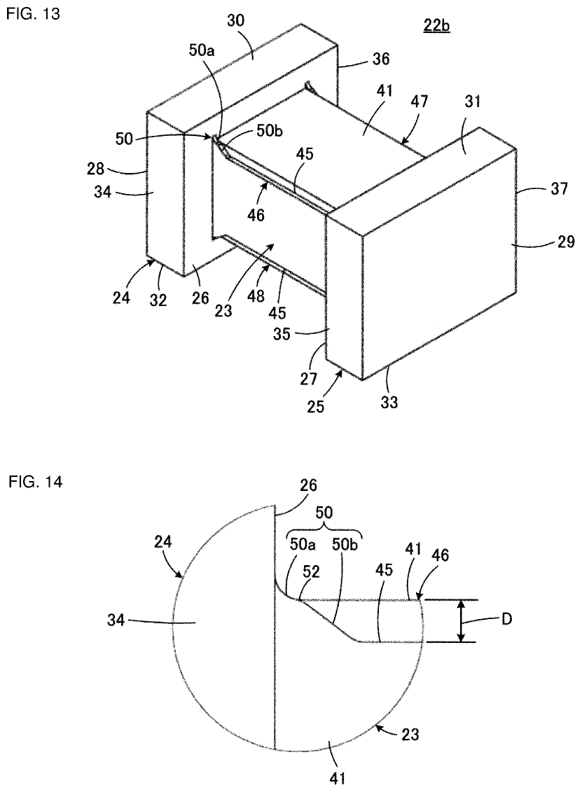

With reference to FIGS. 13 and 14, a core 22b included in a coil component according to a third embodiment of the present disclosure will be described. FIG. 13 is a diagram corresponding to FIGS. 2 and 11. FIG. 14 is a diagram corresponding to FIGS. 8 and 12. In FIG. 13, components corresponding to the components illustrated in FIGS. 2 and 11 are denoted with the same reference signs. In FIG. 14, components corresponding to the components illustrated in FIG. 8 or 12 are denoted with the same reference signs without being described redundantly.

The core 22b has some characteristics the same as those of the core 22a illustrated in FIGS. 11 and 12. Specifically, the core 22b also includes the first sloping surface 50a and the second sloping surface 50b in each recess 45. The first sloping surface 50a includes a concave rounded surface, and the second sloping surface 50b is substantially flat. The boundary 52 between the first sloping surface 50a and the second sloping surface 50b is located at the same position as the peripheral surface 41 of the wire-wound core portion 23 or closer to the center axis of the wire-wound core portion 23 than the peripheral surface 41 in the direction from the peripheral surface 41 toward the center axis, that is, in the direction perpendicular to the mount surface.

In the present embodiment, as illustrated in FIG. 13, each first sloping surface 50a is located within the area where the recess 45 is disposed, instead of extending throughout the periphery of the wire-wound core portion 23.

In the present embodiment, each recess 45 has a depth D greater than that of the recess 45 illustrated in FIG. 12, and the dimension of the second sloping surface 50b in the axial direction of the wire-wound core portion 23 is greater than that of the second sloping surface 50b illustrated in FIG. 12. The dimension of the first sloping surface 50a in the axial direction of the wire-wound core portion 23 is smaller than that illustrated in FIG. 12. These characteristics further improve the mechanical strength of the core 22a without hindering winding of the wire.

In the above second and third embodiments, each sloping surface 50 includes two sloping surfaces, such as the first sloping surface 50a and the second sloping surface 50b, but may include three or more sloping surfaces. Each of the multiple sloping surfaces may have any angle with respect to the inner end surface, any curvature, and any length in the axial direction.

### Fourth Embodiment

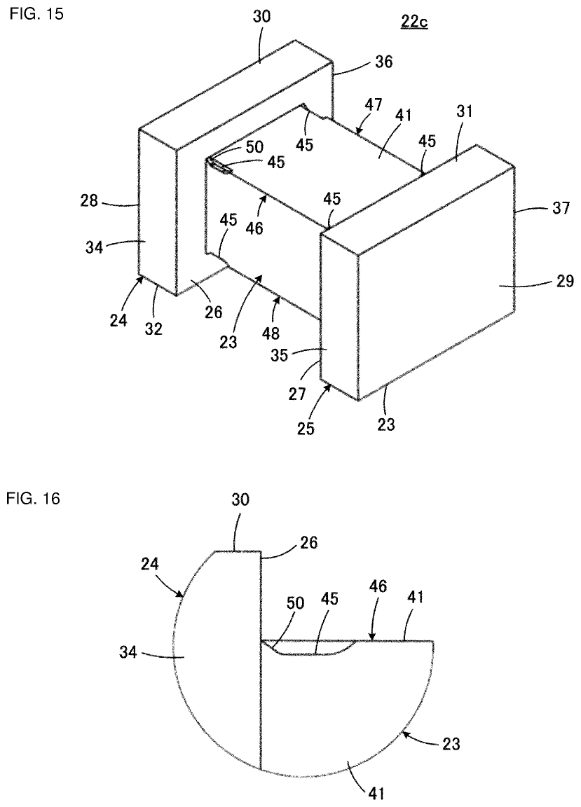

With reference to FIGS. 15 and 16, a core 22c included in a coil component according to a fourth embodiment of the present disclosure will be described. FIG. 15 is a diagram corresponding to FIG. 2, and FIG. 16 is a diagram corresponding to FIG. 8. In FIGS. 15 and 16, components corresponding to the components illustrated in FIG. 2 or 8 are denoted with the same reference signs without being described redundantly.

In the present embodiment, chamfers forming the recesses 45 do not extend throughout the length of the ridges 46 to 49. The recesses 45 are located on the ridges 46 to 49 at only portions adjacent to the first flange 24 and the second flange 25. This structure is based on an idea that each recess 45 may have any size as long as it has the sloping surface 50 formed therein. This structure can minimize reduction of the volume of the core 22c resulting from forming of the recesses 45, and contributes to acquiring of a higher inductance.

### Other Embodiments

Thus far, coil components according to the above embodiments of the present disclosure have been described, but the coil components may be modified in various manners within the scope of the present disclosure.

For example, in the above embodiment, the wire-wound core portion 23 has a substantially quadrangular-prism shape having four ridges extending parallel to each other, but may have a shape of any polygonal prism, instead of a quadrangular prism, or may be substantially cylindrical or elliptic.

In the above embodiment, the recess 45 including the sloping surface 50 is formed by chamfering the ridges 46 to 49 of the wire-wound core portion 23 with a substantially polygonal-prism shape, for example, a substantially quadrangular-prism shape. This structure is assumed to be most effective in improving the mechanical strength of the core including the wire-wound core portion with a substantially polygonal-prism shape, but this structure is not limitative.

For example, only one of the multiple ridges 46 to 49, three of the multiple ridges 46 to 49, or two of the multiple ridges 46 to 49 opposing in the diagonal direction may each have a recess and a sloping surface. In addition, a ridge including no sloping surface may have a recess not including a sloping surface.

The recess including a sloping surface may be located on the wire-wound core portion at any portion where the peripheral surface of the wire-wound core portion crosses the inner end surface of each flange. Thus, the recess including a sloping surface may be located at a position other than the ridges of the wire-wound core portion with a substantially polygonal-prism shape, for example, at a portion between two adjacent ridges.

As described above, for a substantially cylindrical or elliptic wire-wound core portion, the recess including a sloping surface may be basically located on the peripheral surface of the wire-wound core portion at any position where the peripheral surface crosses the inner end surface of each flange. Particularly preferably, the recess including a sloping surface is formed at a portion of the wire-wound core portion facing the mount surface.

Although not illustrated, the coil component 21 may include a top board disposed to couple the top surfaces 32 and 33 of the first flange 24 and the second flange 25. The core 22 and the top board, when both formed from a magnetic material, form a closed magnetic circuit in cooperation with each other. Instead of a top board, a coating material may be applied to cover portions of the wire-wound core portion 23 and the wire 42 closer to the top surfaces 32 and 33 while coupling the top surfaces 32 and 33 of the first flange 24 and the second flange 25 with each other. Preferable examples used as a coating material include a resin containing magnetic powder.

The coil component according to each of the above embodiments includes a single wire. However, the present disclosure is also applicable to a coil component including two or more wires to function as, for example, a common-mode choke coil, or a transformer.

The above-described embodiments are described by way of example, and components of different embodiments may be partially replaced or combined with each other.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

What is claimed is:

1. A coil component comprising:
a core including a wire-wound core portion and flanges, the wire-wound core portion including a peripheral surface and extending in an axial direction, the flanges being disposed on end portions of the wire-wound core portion opposite to each other in the axial direction, and the axial direction of the wire-wound core portion extending parallel to a mount surface,
terminal electrodes disposed at portions of the flanges facing at least the mount surface; and
a wire wound around the peripheral surface of the wire-wound core portion and connected to the terminal electrodes,
wherein each of the flanges includes an inner end surface facing the wire-wound core portion and on which a corresponding one of the end portions of the wire-wound core portion is positioned, and an outer end surface facing outward away from the inner end surface,
recesses are provided at portions of the peripheral surface of the wire-wound core portion in a peripheral direction where the peripheral surface of the wire-wound core portion intersects the inner end surfaces of the flanges,
a sloping surface is in each of the recesses,
the sloping surface is inclined at an obtuse angle with respect to a corresponding one of the inner end surfaces, and
the sloping surface extends in a direction away from the inner end surface.

2. The coil component according to claim 1, wherein
when viewed in a direction perpendicular to the axial direction of the wire-wound core portion and parallel to the mount surface, the sloping surface is inclined at an obtuse angle with respect to the corresponding inner end surface and extends in a direction away from the inner end surface, and
each of the recesses including the sloping surface is disposed at a first side of the peripheral surface of the wire-wound core portion facing at least the mount surface.

3. The coil component according to claim 2, wherein
the recesses, each including the sloping surface, are disposed at the first side of the peripheral surface of the wire-wound core portion facing the mount surface, and at a second side of the peripheral surface of the wire-wound core portion opposite to the first side.

4. The coil component according to claim 1, wherein
the wire-wound core portion has a substantially polygonal-prism shape including a plurality of ridges extending parallel to each other, and
each of the recesses is defined by a chamfer provided at at least one of the ridges.

5. The coil component according to claim 4, wherein
the chamfer is provided throughout a length of the corresponding ridge.

6. The coil component according to claim 4, wherein
the chamfer defines a groove extending along the ridge.

7. The coil component according to claim 4, wherein
the wire-wound core portion has a substantially quadrangular-prism shape including four ridges extending parallel to each other.

8. The coil component according to claim 7, wherein
the chamfer is provided at each of the ridges.

9. The coil component according to claim 1, wherein
the sloping surface includes a flat surface.

10. The coil component according to claim 1, wherein
the sloping surface includes a concave curved surface.

11. The coil component according to claim 1, wherein
an end portion of the sloping surface closer to a corresponding one of the inner end surfaces
is located at a position the same as the peripheral surface of the wire-wound core portion in a direction from the peripheral surface toward the center axis, or
is located at a position closer to a center axis of the wire-wound core portion than the peripheral surface in the direction from the peripheral surface toward the center axis.

12. The coil component according to claim 1, wherein
the sloping surface includes at least a first sloping surface and a second sloping surface continuous with each other in the direction away from a corresponding one of the inner end surfaces,
the first sloping surface and the second sloping surface are arranged in this order in the direction away from the inner end surface, and
the first sloping surface differs from the second sloping surface in terms of at least one of an angle with respect to the inner end surface, a curvature, and a length in the axial direction.

13. The coil component according to claim 12, wherein
a boundary between the first sloping surface and the second sloping surface
is located at a position the same as the peripheral surface of the wire-wound core portion in a direction from the peripheral surface toward the center axis, or
is located at a position closer to the center axis of the wire-wound core portion than the peripheral surface in the direction from the peripheral surface toward the center axis.

14. The coil component according to claim 13, wherein
the first sloping surface extends around an entire periphery of the peripheral surface of the wire-wound core portion at a portion where the peripheral surface of the wire-wound core portion intersects the inner end surface of each of the flanges, and at a side closer to the inner end surface of the flange from the recess.

15. The coil component according to claim 2, wherein
the wire-wound core portion has a substantially polygonal-prism shape including a plurality of ridges extending parallel to each other, and
each of the recesses is defined by a chamfer provided at at least one of the ridges.

16. The coil component according to claim 5, wherein
the chamfer defines a groove extending along the ridge.

17. The coil component according to claim 5, wherein
the wire-wound core portion has a substantially quadrangular-prism shape including four ridges extending parallel to each other.

18. The coil component according to claim 2, wherein
the sloping surface includes a flat surface.

19. The coil component according to claim 2, wherein
the sloping surface includes a concave curved surface.

20. The coil component according to claim 2, wherein
an end portion of the sloping surface closer to a corresponding one of the inner end surfaces
is located at a position the same as the peripheral surface of the wire-wound core portion in a direction from the peripheral surface toward the center axis, or
is located at a position closer to a center axis of the wire-wound core portion than the peripheral surface in the direction from the peripheral surface toward the center axis.
